(19) United States
(12) Patent Application Publication
(10) Pub. No.: US 2026/0071909 A1
(43) Pub. Date: Mar. 12, 2026

(54) WEIGHING SYSTEM, WEIGHING DEVICE, AND WEIGHING METHOD

(71) Applicant: Toshiba Tec Kabushiki Kaisha, Tokyo (JP)

(72) Inventor: Ryosuke OE, Mishima Shizuoka (JP)

(21) Appl. No.: 19/261,542

(22) Filed: Jul. 7, 2025

(30) Foreign Application Priority Data
Sep. 10, 2024 (JP) 2024-155478

(51) Int. Cl. G01G 19/414; G01G 19/415; G06Q 20/20; G06Q 20/32

(52) U.S. Cl. CPC G01G 19/4144; G01G 19/415; G06Q 20/202; G06Q 20/208; G06Q 20/3276

(57) ABSTRACT

According to one embodiment, a transaction processing system for weighed commodities includes a server device and a weighing device. The weighing device has a communication unit connected to the server device and a weighing unit to detect a change in weight of items in a container on the weighing unit. When the weighing unit detects a reduction in the weight of items in the container, the weighing device transmits a weight change notice to the server device via the communication unit. The weight change notice includes a weight change value corresponding to the reduction in weight and a weighing device code identifying the weighing unit. Upon receiving the weight change notice, the server device calculates a registered item price according to the weight change value and an item unit weight associated with the weighing device code in the server device.

### CROSS-REFERENCE TO RELATED APPLICATION

This application is based upon and claims the benefit of priority from Japanese Patent Application No. 2024-155478, filed Sep. 10, 2024, the entire contents of which are incorporated herein by reference.

### FIELD

Embodiments described herein relate generally to a weighing system, a weighing device, and a weighing method for registration of items in a retail transaction at a store or the like.

### BACKGROUND

In the related art, in a retail store such as a supermarket, a system by which a customer performs product registration for registering a commodity to be purchased is widely adopted. Generally, when the customer is purchasing a commodity sold by weight in such a system, the customer must select the particular commodity being sold by weight at a weighing device. The customer then places the commodity on the weighing device to be weighed. In this way, the system acquires the identification of the particular commodity being registered and the weight (amount) of the commodity being purchased.

However, in such a system the customer may perform an erroneous operation since there are many procedures and often multiple options to be selected.

### BRIEF DESCRIPTION OF THE DRAWINGS

FIG. 1 depicts a self-checkout system according to a first embodiment.

FIG. 2 depicts a hardware configuration of a weighing device.

FIG. 3 depicts a hardware configuration of a management server.

FIG. 4 illustrates an example of a data configuration of a commodity price table.

FIG. 5 illustrates an example of a data configuration of a weighing management table.

FIG. 6 depicts a hardware configuration of a customer terminal.

FIG. 7 is a block diagram illustrating functional aspects of devices of a self-checkout system.

FIG. 8 illustrates an example of a registration candidate image.

FIG. 9 is a flowchart of weighing registration processing.

FIG. 10 is a block diagram illustrating functional aspects of devices of a self-checkout system according to a second embodiment.

FIG. 11 is a flowchart of weighing registration processing in a second embodiment.

### DETAILED DESCRIPTION

A transaction processing system for weighed commodities, a weighing system, a weighing device, and a weighing method capable of reducing erroneous operations are provided in the embodiment.

In general, according to one embodiment, a transaction processing system for weighed commodities includes a server device and a weighing device. The weighing device has a communication unit connected to the server device and a weighing unit to detect a change in weight of items in a container on the weighing unit. When the weighing unit detects a reduction in the weight of items in the container, the weighing device transmits a weight change notice to the server device via the communication unit. The weight change notice includes a weight change value corresponding to the reduction in weight and a weighing device code identifying the weighing unit. Upon receiving the weight change notice, the server device calculates a registered item price according to the weight change value and an item unit weight associated with the weighing device code in the server device.

Hereinafter, embodiments of a weighing system, a weighing device, and a weighing method will be described in detail with reference to the accompanying drawings. Embodiments described below are non-limiting examples of a weighing system, a weighing device, and a weighing method.

### First Embodiment

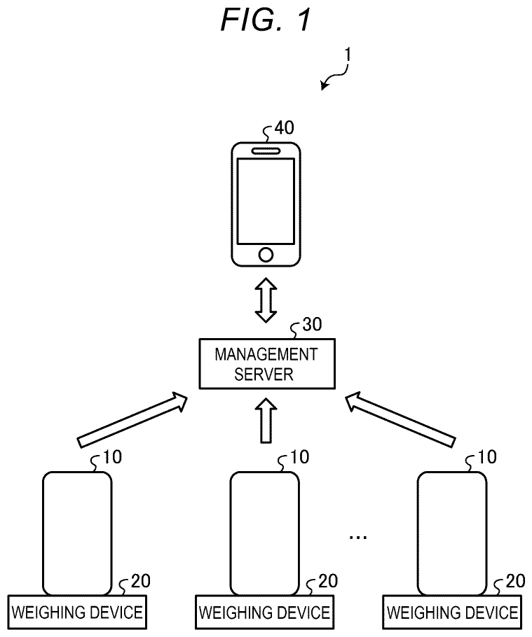

FIG. 1 is a diagram illustrating an example of a self-checkout system 1 according to a first embodiment. The self-checkout system 1 is a system in which commodity registration processing (registering the commodity to be purchased) is executed by an operation of a customer. The self-checkout system 1 also allows the customer to register a commodity sold by weight according to the quantity (weight) desired by the customer.

The self-checkout system 1 includes weighing devices 20. The weighing devices 20 can each weigh a container 10 in which a commodity can be placed. The self-checkout system 1 further includes a management server 30 and one or more customer terminals 40. The weighing devices 20 and the management server 30 are communicably connected. The management server 30 and customer terminals 40 are communicably connected.

The weighing device 20 is a scale that weighs the container 10 in which a commodity sold by weight can be placed. In the present example, each weighing device 20 has a corresponding container 10 in which a particular type of commodity is stored, and then the customer removes the amount (quantity) of the commodity desired to be purchased. The weighing device 20 and the container 10 are generally provided together and associated with one another. Accordingly, the weighing device 20 weighs its container 10 and the commodity that has been placed in the container 10. That is, the weighing device 20 initially weighs the combined weight of the commodity in the container 10 and the container 10. In the present example, the weighing device 20 acquires a weighed value of the commodity taken out from the container 10 by the customer by a subtracting of the combined weighed value after some of the commodity has been taken out from the container 10 by the customer from the initial (pre-removal) combined weighed value of the commodity and the container 10.

The management server 30 is a server device that manages the self-checkout system 1. The management server 30 acquires the weighed value of a commodity from a weighing device 20. The management server 30 calculates a price due for the commodity according to the acquired weighed value of the commodity removed and the identity of the commodity. The management server 30 transmits the calculated price for the (removed) commodity to the customer terminal 40. Then the customer terminal 40 is configured to receive a user (e.g., customer) operation for selecting/identifying the commodity to be purchased. The management server 30 registers the user selection of a commodity as a commodity to be purchased by a customer associated with the customer terminal 40 at which the user operation was received.

The customer terminal 40 is a terminal operated by the customer. For example, the customer terminal 40 is a mobile terminal such as a tablet terminal or a smartphone carried by the customer. The customer terminal 40 is not limited to such terminals and may be a tablet terminal-type commodity registration device mounted on a shopping cart.

The customer terminal 40 displays a list of weighed commodities (those taken out from a container 10) and a price for the weighed commodities based on information received from the management server 30. The customer terminal 40 may be configured to receive an operation for selecting or identifying a weighed commodity. For example, a list of candidates may be displayed to customer on the customer terminal 40. The customer terminal 40 then transmits a registration request for requesting a commodity registration of the selected/identified weighed commodity to the management server 30.

In this way, by using the self-checkout system 1, the customer can conveniently perform a commodity registration on a commodity sold by weight.

Next, a hardware configuration of devices included in the self-checkout system 1 will be described.

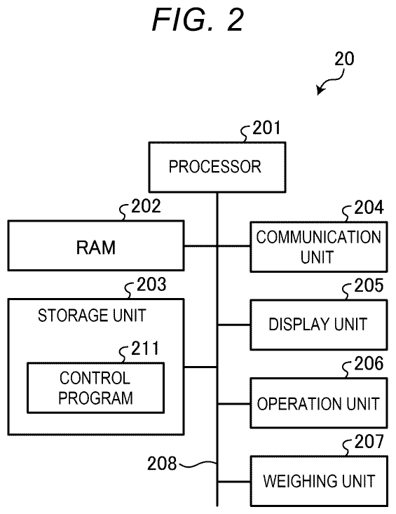

FIG. 2 is a diagram illustrating an example of a hardware configuration of a weighing device 20 according to the first embodiment. The weighing device 20 includes a processor 201, a random access memory (RAM) 202, a storage unit 203, a communication unit 204, a display unit 205, an operation unit 206, and a weighing unit 207. These units are connected via an internal bus 208.

The processor 201 is a processing circuit that controls operations of the weighing device 20, such as a central processing unit (CPU). The RAM 202 is a storage medium that temporarily stores various programs and various types of data. The processor 201 executes a control program 211 stored in the storage unit 203 using the RAM 202 as a work area (working region).

The storage unit 203 is an auxiliary storage device such as a hard disk drive (HDD), a solid-state drive (SSD), or a flash memory. The storage unit 203 stores the control program 211. The control program 211 can be an operating system or a dedicated program for implementing the described functions of the weighing device 20. The control program 211 includes program instructions for implementing the characteristic functions according to the present embodiment.

The communication unit 204 is a communication device such as a network interface card. For example, the communication unit 204 performs communication via a network.

The display unit 205 is an output device such as a liquid crystal display or an organic electro luminescence (EL) display.

The operation unit 206 is an input device that receives various user input operations, such as a keyboard, a mouse, or a touch panel provided in the display unit 205.

The weighing unit 207 is a sensor that outputs an electric signal corresponding to a load on a load cell or the like.

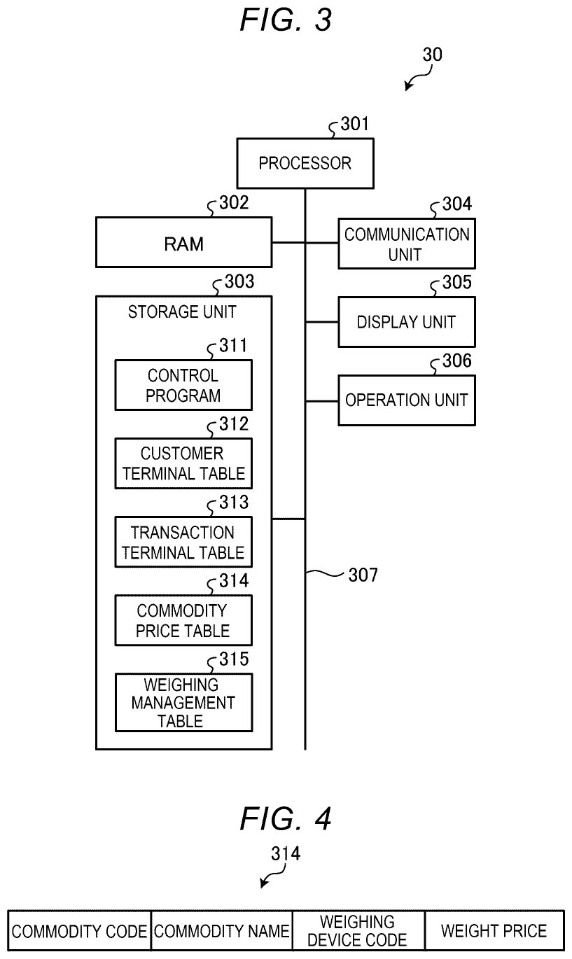

FIG. 3 is a diagram illustrating an example of a hardware configuration of the management server 30 according to the first embodiment. The management server includes a processor 301, a RAM 302, a storage unit 303, a communication unit 304, a display unit 305, and an operation unit 306. These units are connected via an internal bus 307.

The processor 301 is a processing circuit that controls operations of the management server 30, such as a CPU. The RAM 302 is a storage medium that temporarily stores various programs and various types of data. The processor 301 executes a control program 311 stored in the storage unit 303 using the RAM 302 as a work area (working region).

The storage unit 303 is an auxiliary storage device such as an HDD, an SSD, or a flash memory. The storage unit 303 stores the control program 311, a transaction terminal table 313, a commodity price table 314, and a weighing management table 315. The transaction terminal table 313, the commodity price table 314, and the weighing management table 315 are not limited to being stored in the storage unit 303 of the management server 30 and may be stored in another device.

The control program 311 can be an operating system or a dedicated program for implementing the described functions of the management server 30. The control program 311 includes program instructions for implementing characteristic functions according to the present embodiment.

A customer terminal table 312 is an information table storing information about the customer terminal(s) 40. The customer terminal table 312 is an information table in which a customer terminal code and notification destination information are associated with each other. The customer terminal code is identification information for identifying the particular customer terminal 40. The notification destination information is information indicating a notification destination for the customer terminal 40. For example, the notification destination information is information such as an account on a social networking service (SNS), a mail address, or a telephone number.

The transaction terminal table 313 is an information table storing information about the customer terminal 40 that is executing a transaction. In other words, the transaction terminal table 313 is an information table having the customer terminal code indicating a presently active customer terminal 40. The information about the customer terminal 40 is not limited to a customer terminal code and may be other information. For example, the information about the customer terminal 40 may be a customer code for identifying a customer who uses the customer terminal 40 or may be other information.

FIG. 4 is a diagram illustrating an example of a data configuration of the commodity price table 314. The commodity price table 314 is an information table providing a price per unit weight of each commodity (or at least such commodity having a weight dependent unit price or the like). More specifically, the commodity price table 314 has information in which a commodity code, a commodity name, a weighing device code, and a weight price (unit price) are associated with one another. The commodity code is identification information for identifying a commodity. The commodity name is information indicating a name of a commodity. The weighing device code is identification information for identifying the weighing device 20 for the container 10 in which the commodity is placed. The weight price is information indicating a price per unit weight of the commodity.

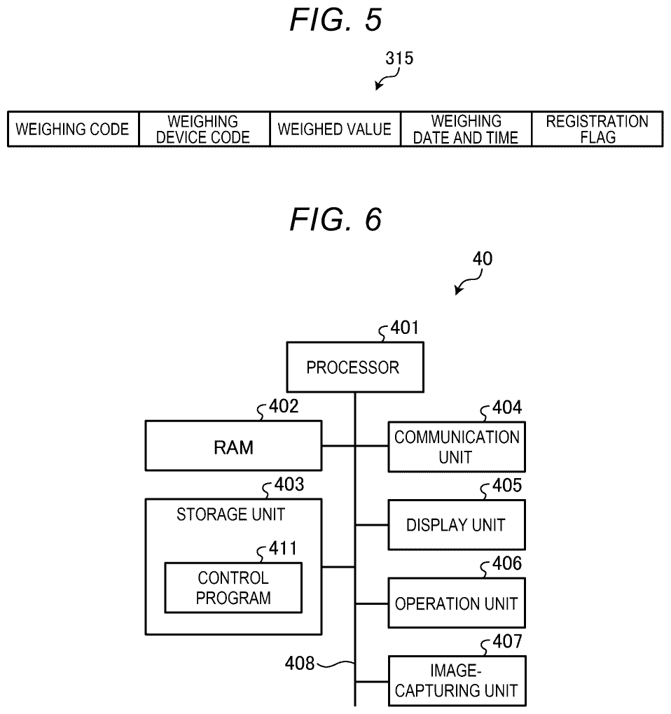

FIG. 5 is a diagram illustrating an example of a data configuration of the weighing management table 315. The weighing management table 315 is an information table having information about a weighed value of a commodity provided by a weighing device 20. The weighing management table 315 has information in which a weighing code, a weighing device code, a weighed value, a weighing date and time, and a registration flag are associated with one another.

The weighing code is identification information for identifying each weighing event performed at a weighing device 20. The weighing device code is information indicating the particular weighing device 20 that performs weighing. The weighed value is information indicating a weight of the taken-out commodity as weighed by the weighing device 20. The weighing date and time is information indicating the date and time of the weighing event performed at the weighing device 20. The registration flag is a flag indicating whether the taken-out commodity at the weighed value has been registered in a sales transaction.

Here, the management server 30 transmits the weighed value obtained by the weighing device 20 to a customer terminal 40 during the commodity registration processing. The customer then uses the customer terminal 40 for selecting the acquired weighed value of the commodity to be registered for purchase. Accordingly, the customer performs a commodity registration for the selected commodity at the weighed value. The registration flag is a flag (e.g., single bit data or the like) indicating whether the commodity has been registered.

The communication unit 304 is a communication device such as a network interface card. For example, the communication unit 304 performs communication via a network.

The display unit 305 is an output device such as a liquid crystal display or an organic EL display.

The operation unit 306 is an input device that receives various user input operations, such as a keyboard or a mouse.

FIG. 6 is a diagram illustrating an example of a hardware configuration of a customer terminal 40 according to the first embodiment. The customer terminal 40 includes a processor 401, a RAM 402, a storage unit 403, a communication unit 404, a display unit 405, an operation unit 406, and an image-capturing unit 407. These units are connected via an internal bus 408.

The processor 401 is a processing circuit that controls operations of the customer terminal 40, such as a CPU. The RAM 402 is a storage medium that temporarily stores various programs and various types of data. The processor 401 executes a control program 411 stored in the storage unit 403 using the RAM 402 as a work area (working region).

The storage unit 403 is an auxiliary storage device such as an HDD, an SSD, or a flash memory. The storage unit 403 stores the control program 411. The control program 411 is an operating system or a dedicated program for implementing the described functions of the customer terminal 40. The control program 411 includes program instructions for implementing characteristic functions according to the present embodiment.

The communication unit 404 is a communication device such as a network interface card. For example, the communication unit 404 performs communication via a network.

The display unit 405 is an output device such as a liquid crystal display or an organic EL display.

The operation unit 406 is an input device that receives various user input operations, such as a keyboard, a mouse, or a touch panel provided in the display unit 405.

The image-capturing unit 407 is a digital camera including an image-capturing element such as a charge-coupled device (CCD) or a complementary metal oxide semiconductor (CMOS).

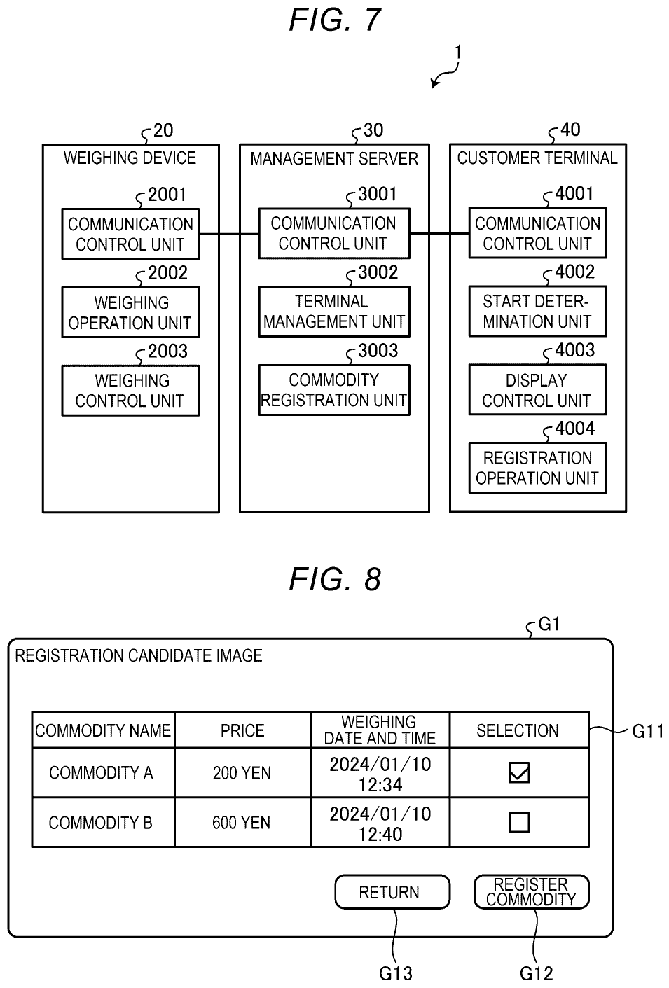

Next, functions of the devices of the self-checkout system 1 will be described. FIG. 7 is a block diagram illustrating an example of a functional configuration of devices of the self-checkout system 1 according to the first embodiment.

The processor 201 included in the weighing device 20 loads the control program 211 stored in the storage unit 203 onto the RAM 202 and operates according to the control program 211 to generate each depicted functional unit in the RAM 202. Accordingly, the processor 201 included in the weighing device 20 provides the functions of a communication control unit 2001, a weighing operation unit 2002, and a weighing control unit 2003.

The communication control unit 2001 controls the communication unit 204 to execute communication via a network. For example, the communication control unit 2001 transmits weighing information indicating a weighing result to the management server 30.

The weighing operation unit 2002 controls the operation unit 206 to receive various user input operations. For example, the weighing operation unit 2002 receives an operation for weighing of a commodity stored in the container 10. In other words, the weighing operation unit 2002 receives an operation for weighing the commodity taken out from the container 10.

The weighing control unit 2003 controls the weighing unit 207 to acquire the weighed value of the commodity taken out from the container 10. That is, when the commodity in the container 10 associated with the weighing device 20 is taken out by the customer, the weighing control unit 2003 acquires a removed commodity weight as a value of the difference between weight before the commodity is removed from the container 10 by the customer the weight of the container after the commodity is removed from the container 10. More specifically, the weighing control unit 2003 acquires a weighed value indicating the weight of the commodity taken out from the container 10 by subtracting the weighed value after the commodity removal from the container 10 from the weighed value before the commodity was removed from the container 10.

Here, whenever the weighed value changes within a specified period, it is considered that a customer is taking some amount of the commodity out of the container 10. Therefore, whenever the weighing operation unit 2002 receives an indication of a sufficient weight change, the weighing control unit 2003 determines that the commodity has been taken out from the container 10 after the weighed value does not change substantially within some specified period. When the weighing control unit 2003 determines that the commodity has been taken out, the weighing control unit 2003 acquires a new weighed value. Then, the weighing control unit 2003 acquires the weight of the commodity taken out from the container 10 by subtracting the new weighed value from the old (previous) weighed value before the commodity was taken out from the container 10.

When the weighing control unit 2003 acquires a weighed value, the weighing control unit 2003 generates weighing information including the acquired weighed value (indicating the weight of the commodity removed), the weighing date and time indicating the date and time when the weighed value was acquired, and the weighing device code indicating a host device or the particular weighing device 20. Then, the communication control unit 2001 transmits the generated weighing information to the management server 30.

The processor 301 included in the management server 30 loads the control program 311 stored in the storage unit 303 onto the RAM 302 and operates according to the control program 311 to generate each described functional unit in the RAM 302. Accordingly, the processor 301 included in the management server 30 provides the functions of a communication control unit 3001, a terminal management unit 3002, and a commodity registration unit 3003.

The communication control unit 3001 controls the communication unit 304 to execute communication via a network.

For example, the communication control unit 3001 receives transaction start information from the customer terminal 40 indicating that the transaction has been started. The communication control unit 3001 also receives the weighing information indicating a weighing result from the weighing device 20.

For example, the communication control unit 3001 transmits, to the customer terminal 40, registration candidate information including information about a candidate commodity to be registered. The communication control unit 3001 receives a registration request from the customer terminal 40 for requesting registration of a commodity included in the registration candidate information.

The terminal management unit 3002 manages information about the customer terminals 40.

For example, when the communication control unit 3001 receives transaction start information, the terminal management unit 3002 registers the customer terminal code included in the received transaction start information in the transaction terminal table 313.

The terminal management unit 3002 extracts the customer terminal 40 corresponding to a customer who may acquire the commodity from the container 10. For example, the terminal management unit 3002 extracts the customer terminal 40 used in the commodity registration processing in a retail store as the customer terminal 40 corresponding to the customer who may purchase the commodity.

Specifically, when the communication control unit 3001 receives the weighing information, the terminal management unit 3002 extracts the customer terminal 40 identified by the customer terminal code registered in the transaction terminal table 313 as the customer terminal 40 corresponding to the customer who may purchase the commodity. The terminal management unit 3002 acquires, based on the customer terminal table 312, the notification destination information of the customer terminal 40 identified by the extracted customer terminal code.

The commodity registration unit 3003 controls the commodity registration processing for registering the commodities to be sold. More specifically, when the communication control unit 3001 receives the weighing information, the commodity registration unit 3003 generates a weighing code. The weighing code is the identification information for identifying the particular weighing of the commodity performed at a weighing device 20. The commodity registration unit 3003 registers, in the weighing management table 315, weighing management information in which the newly generated weighing code, the weighed value included in the weighing information, the weighing device code, the weighing date and time, and a registration flag are associated with one another.

After registering the weighing management information in the weighing management table 315, the commodity registration unit 3003 generates registration candidate information for each entry of weighing management information registered in the weighing management table 315. More specifically, the commodity registration unit 3003 acquires the weighing code, the weighing device code, the weighed value, and the weighing date and time from the weighing management information stored in the weighing management table 315.

The commodity registration unit 3003 acquires the commodity code, the commodity name, and the weight unit price corresponding to the acquired weighing device code based on the commodity price table 314. The commodity registration unit 3003 calculates the price due for the commodity taken out from the container 10 based on the weighed value indicating the weight of the removed commodity and the weight unit price corresponding to the commodity code of the removed commodity. The commodity registration unit 3003 is an example of a calculation unit. In other words, the commodity registration unit 3003 calculates the price of the commodity based on the commodity price table 314 in which the weighing device code indicating the weighing device 20 and the weight price per unit weight of the commodity are associated with each other. In this way, the commodity registration unit 3003 generates the registration candidate information having a weighing code, a commodity name, a price, and a weighing date and time.

The commodity registration unit 3003 generates the registration candidate information for each entry of weighing management by information executing the above-described processing on each entry of weighing management information registered in the weighing management table 315. In other words, the commodity registration unit 3003 generates registration candidate information for each commodity weighing event performed at the weighing device 20. Then, the communication control unit 3001 transmits the registration candidate information generated by the commodity registration unit 3003 to a customer terminal 40 at the notification destination information acquired by the terminal management unit 3002.

When the communication control unit 3001 receives the registration request, the commodity registration unit 3003 registers the commodity associated with the weighing code included in the registration request. More specifically, the commodity registration unit 3003 acquires, from the weighing management table 315, the weighing device code and the weighed value associated with the weighing code included in the received registration request. The commodity registration unit 3003 acquires the commodity code, the commodity name, and the weight unit price corresponding to the weighing device code based on the commodity price table 314. The commodity registration unit 3003 calculates a price due for the removed commodity according to the weight unit price and the weighed value. Then, the commodity registration unit 3003 registers the commodity code, the commodity name, the price, and the weighing date and time as information about a commodity to be purchased.

The processor 401 included in the customer terminal 40 loads the control program 411 stored in the storage unit 403 into the RAM 402 and operates according to the control program 411 to generate each described functional unit in the RAM 402. Accordingly, the processor 401 included in the customer terminal 40 provides the functions of a communication control unit 4001, a start determination unit 4002, a display control unit 4003, and a registration operation unit 4004.

The communication control unit 4001 controls the communication unit 404 to execute communication via a network. For example, the communication control unit 4001 transmits, to the management server 30, the transaction start information notifying that a transaction has been started. The communication control unit 4001 also receives, from the management server 30, the registration candidate registration candidate. The communication control unit 4001 also transmits a registration request for requesting a commodity registration to the management server 30.

The start determination unit 4002 identifies the start of a transaction. More specifically, the start determination unit 4002 determines that the commodity registration processing has started based on some event.

In general, the start determination unit 4002 may identify the start of a transaction based on any event. For example, the start determination unit 4002 determines that the transaction has started when a predetermined operation, such as the pressing of a transaction start button, occurs. In some examples, the start determination unit 4002 determines that the transaction has started when it is detected that the user has entered a retail store. For example, the start determination unit 4002 determines that the user enters a retail store when a beacon signal is received via short-range wireless communication or when a code symbol provided inside the retail store is read by a customer terminal 40 or the like. For example, the start determination unit 4002 determines that the transaction has started when an shopping application is activated on a customer terminal 40.

The display control unit 4003 controls the display unit 405 to display various images. For example, when the communication control unit 4001 receives the registration candidate information, the display control unit 4003 displays a registration candidate image G1 (see FIG. 8) on the display unit 405.

FIG. 8 is a diagram illustrating an example of the registration candidate image G1. The registration candidate image G1 is an image permitting the selection of a commodity to be purchased from one or more registration candidates. The customer selects the particular commodity that customer previously removed from a container 10 as displayed as a candidate in the registration candidate image G1. The registration candidate image G1 includes a list image G11, a commodity registration button G12, and a return button G13.

The list image G11 displays a list of the registration candidates. That is, the list image G11 includes a commodity name, a price, a weighing date and time, and a check box for each registration candidate in registration candidate information received by the communication control unit 4001. The display control unit 4003 displays the commodity name, the price, and the weighing date and time for each registration candidate. The display control unit 4003 is an example of a first display control unit. The display control unit 4003 further displays a check box for selecting whether to register the registration candidate as a commodity to be purchased. The check box receives an operation for designating the candidate commodity as one to be purchased.

The commodity registration button G12 is a button for receiving an input operation for registering the selected registration candidates to be purchased. The return button G13 is a button for receiving an input operation for returning to an image (screen) displayed before the registration candidate image G1 was displayed. In other words, the return button G13 is a button for canceling the registration operation with respect to registration candidates.

The registration operation unit 4004 controls the operation unit 406 to receive the input operation(s) for designating the commodities to be purchased. More specifically, the registration operation unit 4004 receives the designating of a commodity to be purchased via the registration candidate image G1. The registration operation unit 4004 is an example of an operation control unit. For example, the registration operation unit 4004 receives an operation of selecting the check box in the list image G11. The registration operation unit 4004 further receives an operation of pressing the commodity registration button G12 or the return button G13.

Next, processing executed in the self-checkout system 1 will be described.

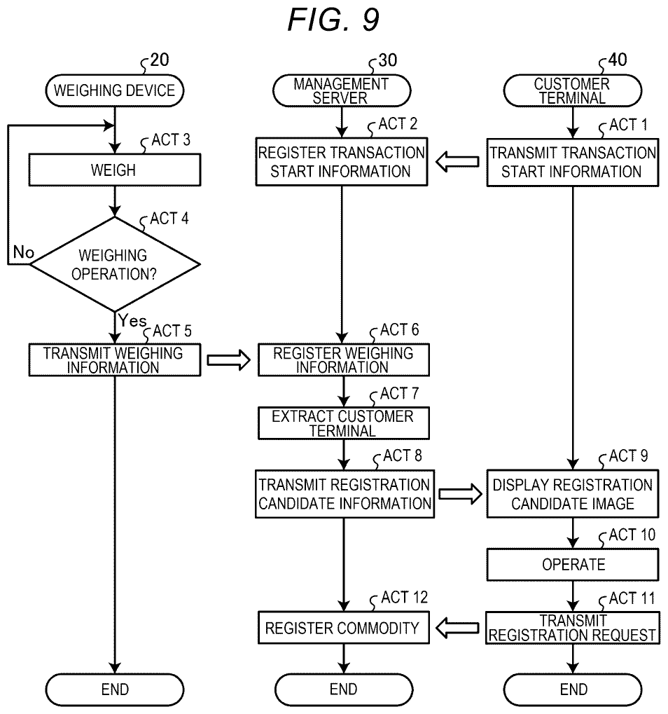

FIG. 9 is a flowchart of weighing registration processing executed by the devices of the self-checkout system 1 according to the first embodiment.

When the start determination unit 4002 determines that the transaction is started, the communication control unit 4001 of the customer terminal 40 transmits the transaction start information to the management server 30 (ACT 1).

The terminal management unit 3002 of the management server 30 registers the transaction start information received from the customer terminal 40 in the transaction terminal table 313 (ACT 2).

The weighing control unit 2003 of the weighing device 20 weighs the container 10 and the commodity therein (ACT 3). The weighing operation unit 2002 determines whether a change in measured weight is received (ACT 4). If not (No in ACT 4), the weighing operation unit 2002 returns to ACT 3.

If a weight change is received (Yes in ACT 4), the communication control unit 2001 transmits the weighing information including the weighing device code of the weighing device the weighed value indicating the weight of the commodity removed, and the weighing date and time (ACT 5).

The commodity registration unit 3003 of the management server 30 registers the weighing management information in the weighing management table 315 (ACT 6) based on the weighing information received from the weighing device 20.

The terminal management unit 3002 of the management server 30 extracts, based on the transaction terminal table 313 in which the transaction start information was registered in ACT 2, the customer terminal 40 corresponding to the customer who may purchase the removed commodity (ACT 7).

The communication control unit 3001 transmits one or more pieces of weighing management information in the weighing management table 315 based on the notification destination information of the extracted customer terminal 40 (ACT 8).

The display control unit 4003 of the customer terminal 40 displays the registration candidate image G1 on the display unit 405 based on the weighing management information received from the management server 30 (ACT 9).

The registration operation unit 4004 receives an operation for registering a commodity to be purchased via the registration candidate image G1 (ACT 10).

The communication control unit 4001 transmits a registration request with a weighing code corresponding to the registration candidate identified by the operation received in ACT 10 (ACT 11).

The commodity registration unit 3003 of the management server 30 performs, based on the weighing management table 315, commodity registration of the weighed value, the commodity name, and the price identified by the weighing code included in the registration request received from the customer terminal 40 (ACT 12).

The self-checkout system 1 according to the first embodiment then ends the weighing registration processing.

The self-checkout system 1 according to the first embodiment acquires a weight of the removed commodity based on a change in weight (as measured by the weighing device 20) before and after the removal of the commodity from the container 10. The self-checkout system 1 calculates the price of the commodity removed from the container 10 based on the weight of the commodity removed and the weight price per unit weight of the commodity associated with the particular weighing device 20. In this case, a customer or the like can acquire the price of the commodity to be purchased simply by taking the commodity out the container 10 without performing any additional operation such as placing the commodity on a scale. Therefore, the self-checkout system 1 can reduce erroneous operations.

### Modification 1

In the first embodiment, the terminal management unit 3002 transmits the registration candidate information to the customer terminals 40 identified by the customer terminal codes registered in the transaction terminal table 313.

However, in modification, the terminal this management unit 3002 may narrow down the customer terminals 40 to which the registration candidate information is to be transmitted. For example, based on position information indicating a position of the customer terminal 40 in the store, the terminal management unit 3002 may extract only the customer terminal(s) 40 within a specified range from the weighing device 20. The terminal management unit 3002 is an example of an extraction unit. More specifically, the terminal management unit 3002 identifies those customer terminals 40 present within the specified range from the weighing device 20 matching the weighing device code included in the weighing information at the or near the time indicated by the weighing date and time included in the weighing information. The communication control unit 3001 may transmit the registration candidate information to only the customer terminals 40 identified by the terminal management unit 3002 based on these conditions with respect to location and time.

In general, the terminal management unit 3002 may acquire the position information of a customer terminal 40 by any method. For example, the terminal management unit 3002 transmits a beacon signal by Bluetooth low energy (BLE) and acquires a radio wave strength of the beacon signal received by the customer terminal 40. The terminal management unit 3002 may acquire the position information indicating the position of a customer terminal 40 based on the radio wave strength of the beacon signal received by the customer terminal 40. Alternatively, the terminal management unit 3002 may acquire the position information indicating the position of the customer terminal 40 by a wireless local area network (LAN) such as Wi-Fi.

### Second Embodiment

A self-checkout system 1a according to a second embodiment executes commodity registration with a processing flow different from that of the first embodiment.

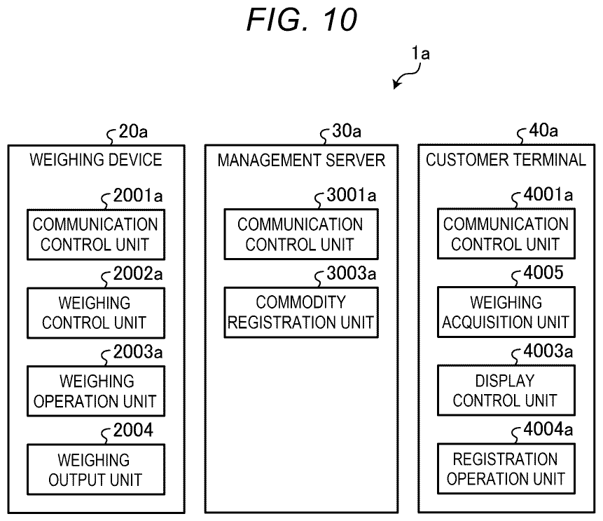

FIG. 10 is a block diagram illustrating an example of a functional configuration of devices of the self-checkout system 1a according to the second embodiment.

The processor 201 of a weighing device 20a provides the functions of a communication control unit 2001a, a weighing control unit 2002a, a weighing operation unit 2003a, and a weighing output unit 2004.

The communication control unit 2001a receives a registration complete notification from a management server 30a for notifying that a commodity registration of a weighed commodity has been performed.

The weighing control unit 2002a controls the weighing unit 207 to acquire a weighed value indicating a weight of a commodity taken out from the container 10 associated with the weighing device 20a. That is, when the commodity in the container 10 is taken out, the weighing control unit 2002a acquires a differential weight value for the before and after removal weighed values. More specifically, the weighing control unit 2002a acquires the weight of the commodity taken out from the container 10 by subtracting the weighed value after the commodity has been taken out from the container 10 from the weighed value before the commodity was taken out from the container 10.

When the communication control unit 2001a receives a registration complete notification, the weighing control unit 2002a initializes the weighed value before the commodity was taken out from the container 10. In other words, when the commodity registration of the weighed commodity is performed, the weighing control unit 2002a sets a current weighed value as the weighed value to be used as the before value for the next registration event at the weighing device 20a.

The weighing operation unit 2003a receives an operation for weighing the commodity in the container 10. When the weighed value changes within a specified period, it is considered that the customer has taken some amount of the commodity from the container 10. Therefore, the weighing operation unit 2003a displays, on the display unit 205, a weighing button for receiving an operation for requesting a weighing after the weighed value obtained by weighing performed by the weighing unit 207 does not change within a specified period. Then, the weighing operation unit 2003a receives the operation for a weighing via the weighing button.

When the communication control unit 2001a receives the registration complete notification, the weighing operation unit 2003a initializes the display of the weighing button. In other words, the weighing operation unit 2003a erases the weighing button when the commodity registration of the weighed commodity has been performed.

The weighing output unit 2004 outputs the weighing information and the price of the commodity taken out from the container 10 when the operation for weighing is received. For example, when the weighing button displayed on the display unit 205 is pressed, the weighing output unit 2004 calculates the price of the commodity taken out from the container 10 based on the weighed value indicating the weight of the commodity weighed by the weighing control unit 2002a and the weight price indicating the price per unit weight of the commodity stored in the storage unit 203, or the like. The weighing output unit 2004 is an example of the calculation unit. Then, the weighing output unit 2004 displays, on the display unit 205, a code symbol obtained by encoding information including the price of the removed commodity and the weighing information. The weighing output unit 2004 is an example of a second display control unit. The code symbol is, for example, a barcode such as Non-price look up (PLU). That is, the code symbol is an image in which the commodity code included in the weighing information, the weighed value included in the weighing information, and the price of the commodity are coded.

The weighing output unit 2004 is not limited to a displaying of the code symbol and may display the price of the commodity or the weighed value on the display unit 205. The weighing output unit 2004 may further display information about the removed commodity such as a commodity name stored in the storage unit 203, or the like.

When the communication control unit 2001a receives the registration complete notification, the weighing output unit 2004 initializes the display of the code symbol. In other words, the weighing operation unit 2003a erases the displayed code symbol.

The weighing output unit 2004 is not limited to a displaying of the code symbol and may output the weighing information by another method. For example, the weighing output unit 2004 may output the weighing information by transmitting the weighing information by short-range wireless communication, may output the weighing information by displaying the weighing information on the display unit 205, or may output the weighing information by another method.

The processor 301 of the management server 30a provides the functions of a communication control unit 3001a and a commodity registration unit 3003a.

The communication control unit 3001a controls the communication unit 304 to execute communication via a network. The communication control unit 3001a receives a registration request for requesting commodity registration from a customer terminal 40a. The communication control unit 3001a transmits the registration complete notification notifying that the commodity registration is performed to the weighing device 20a.

The commodity registration unit 3003a controls commodity registration processing. More specifically, when the communication control unit 3001a receives the registration request, the commodity registration unit 3003a executes the commodity registration based on the weighing information included in the registration request. The commodity registration unit 3003a acquires, based on the commodity price table 314, the commodity code, the commodity name, and the weight price corresponding to the weighing device code included in the weighing information. The commodity registration unit 3003a calculates a price from the acquired weight price and the weighed value included in the weighing information. The commodity registration unit 3003a executes the commodity registration for registering information including the commodity code, the commodity name, and the price.

When the commodity registration is executed, the communication control unit 3001a transmits the registration complete notification notifying that the commodity registration has been performed to the weighing device 20a as identified by the weighing device code included in the weighing information used for the commodity registration.

The processor 401 of the customer terminal 40a provides the functions of a communication control unit 4001a, a weighing acquisition unit 4005, a display control unit 4003a, and a registration operation unit 4004a.

The communication control unit 4001a transmits a registration request for requesting commodity registration to the management server 30a.

The weighing acquisition unit 4005 acquires the weighing information of the commodity and the price of the commodity weighed by the weighing device 20a. More specifically, the weighing acquisition unit 4005 controls the image-capturing unit 407 to scan the code symbol displayed by the weighing device 20a. Accordingly, the weighing acquisition unit 4005 acquires the weighing information and the price of the commodity.

The weighing acquisition unit 4005 is not limited to the scanning of the code symbol and may acquire the weighing information and the price of the commodity by another method. For example, the weighing acquisition unit 4005 may acquire the weighing information and the price of the commodity by receiving the weighing information and the price of the commodity through short-range wireless communication, may acquire the weighing information and the price of the commodity by an operation of manually inputting the weighing information and the price of the commodity displayed on the display unit 405, or may acquire the weighing information and the price of the commodity by another method.

The display control unit 4003a controls the display unit 405 to display various images. For example, the display control unit 4003a displays a registration confirmation image on the display unit 405 based on the weighing information and the price of the commodity acquired by the weighing acquisition unit 4005. That is, after the weighing acquisition unit 4005 reads the code symbol, the display control unit 4003a displays a registration confirmation: image including the price of the commodity taken out from the container 10.

The registration confirmation image is an image for requesting a user confirmation of whether to perform the commodity registration. The registration confirmation image includes a registration commodity image, a registration button, and a cancel button. The registration commodity image provides information about the commodity to be registered, such as a price and a weighed value. The registration button is a button for receiving an operation for performing the commodity registration on a commodity having the weighed value or the price indicated in the registration commodity image. The cancel button is a button for receiving an operation for canceling the commodity registration of the commodity having the weighed value or the price indicated in the registration confirmation image.

The registration operation unit 4004a receives a confirmation as to whether to register the commodity identified by the weighing information acquired from the weighing device 20a. For example, the registration operation unit 4004a receives the operation of registering the commodity as the commodity to be purchased in response to a pressing of the registration button in the registration confirmation image displayed on the display unit 405.

The registration operation unit 4004a may receive a confirmation operation as to whether to register the commodity as the commodity to be purchased, but such confirmation operation is not limited to pressing a registration button or a cancel button. For example, the registration operation unit 4004a may receive a confirmation by a pressing of a button other than the registration button or the cancel button, may receive a cancel operation by an operation of erasing the registration confirmation image, or may receive an operation as to whether to perform registration by another means.

When the registration operation unit 4004a receives the operation for performing commodity registration, the communication control unit 4001a transmits the registration request including the weighing information acquired by the weighing acquisition unit 4005 to the management server 30a. In contrast, when the registration operation unit 4004a receives an operation of canceling the commodity registration, the communication control 4001a unit does not transmit the registration request.

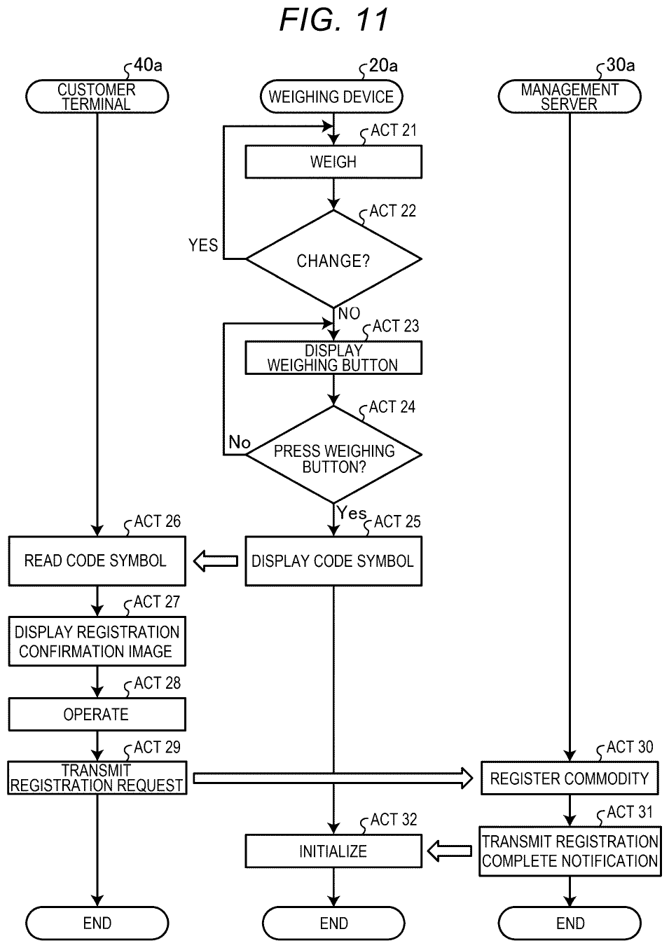

FIG. 11 is a flowchart illustrating an example of weighing registration processing executed by the devices of the self-checkout system 1a according to the second embodiment.

The weighing control unit 2002a of the weighing device 20a outputs the combined measured weight of commodity placed in the container 10 and the container 10 (ACT 21).

The weighing operation unit 2003a checks whether the weighed value changes over a specified period of time (ACT 22). If there is a change in the weighed value within the specified period (Yes in ACT 22), the weighing operation unit 2003a waits because the weight change may indicate the customer is still removing the commodity from the container 10.

On the other hand, if there is no change in the weighed value over the specified period (No in ACT 22), the weighing operation unit 2003a displays the weighing button on the display unit 205 (ACT 23).

The weighing operation unit 2003a checks whether the pressing of the weighing button is detected (ACT 24). If the pressing of the weighing button is not yet detected (No in ACT 24), the weighing operation unit 2003a waits.

If the pressing of the weighing button is detected (Yes in ACT 24), the weighing output unit 2004 displays, on the display unit 205, the code symbol obtained by encoding the information including the weighed value indicating the removed weight of the commodity by the weighing unit 207 (ACT 25).

The weighing acquisition unit 4005 of the customer terminal 40a acquires the weighing information including the weighed value by reading the code symbol (ACT 26).

The display control unit 4003a displays, based on the weighing information including the weighed value, the registration confirmation image for requesting confirmation of whether to perform commodity registration on the commodity (ACT 27).

The registration operation unit 4004a receives the operation for performing the commodity registration via the registration confirmation image (ACT 28).

The communication control unit 4001a transmits the registration request to the management server 30a (ACT 29).

The commodity unit 3003a of the management server 30a performs commodity registration on the commodity having the weighed value included in the weighing information (ACT 30).

The communication control unit 3001a transmits the registration complete notification to the weighing device 20a notifying that the commodity registration has been performed (ACT 31).

The weighing device 20a performs initialization (ACT 32). For example, the weighing control unit 2002a initializes the weighed value. The weighing output unit 2004 erases the code symbol.

The self-checkout system 1a according to the second embodiment then ends the weighing registration processing.

As described above, the self-checkout system 1a according to the second embodiment acquires the weight subtracted from the weighed value before the commodity is taken out as a weight of the commodity taken out from the container 10 when the commodity placed in the container 10 with the weighing device 20a is taken out. The self-checkout system 1a calculates the price of the commodity taken out from the container 10 based on the weight of the commodity and the weight price per unit weight of the commodity. The customer terminal 40a can register the commodity by reading the code symbol displayed by the weighing device 20a. Therefore, the self-checkout system 1a can reduce erroneous operations.

The programs executed by each device in the embodiments and the modifications described above can be provided by being incorporated in advance in a storage medium (the ROM or the storage unit) in each device but is not limited thereto. For example, the program may be provided by being recorded in a non-transitory, computer-readable recording medium such as a CD-ROM, a flexible disk (FD), a CD-R, or a digital versatile disk (DVD) in a file in an installable or executable format.

The program executed by each device in the embodiments and the modifications described above may be stored in a computer connected to a network such as the Internet and provided by being downloaded via the network, or may be accessed or distributed via a network such as the Internet.

While certain embodiments have been described, these embodiments have been presented by way of example only and are not intended to limit the scope of the disclosure. The novel embodiments can be implemented in various other forms, and various omissions, substitutions, and modifications can be made without departing from the gist of the exemplary embodiments. The accompanying embodiments and their equivalents are intended to cover such forms or modifications as would fall within the scope and spirit of the disclosure.

What is claimed is:

1. A transaction processing system for weighed commodities, the transaction processing system comprising:
a server device; and
a weighing device including:
a communication unit connected to the server device; and
a weighing unit configured to detect a change in weight of items in a container on the weighing unit, wherein
when the weighing unit detects a reduction in the weight of items in the container, the weighing device transmits a weight change notice to the server device via the communication unit, the weight change notice including a weight change value corresponding to the reduction in weight and a weighing device code identifying the weighing unit, and
upon receiving the weight change notice, the server device calculates a registered item price according to the weight change value and an item unit weight associated with the weighing device code in the server device.

2. The transaction processing system according to claim 1, wherein the server device is further configured to:
send a notification indicating the registered item price and an item identification to a mobile terminal connected to the server device.

3. The transaction processing system according to claim 2, wherein the server device is further configured to:
receive a registration confirmation from the mobile terminal; and
register the item identification and the registered item price in a transaction list associated with the mobile terminal.

4. The transaction processing system according to claim 2, wherein the server device is further configured to identify the mobile terminal based on a proximity to the weighing device.

5. The transaction processing system according to claim 2, wherein the server device is further configured to send the notification to a plurality of mobile terminals connect to the server device.

6. The transaction processing system according to claim 1, further comprising:
a mobile terminal configured to execute a shopping application associated with a store in which the weighing device is located, the shopping application permitting a customer to register items for purchase in a sales transaction at the store.

7. The transaction processing system according to claim 6, wherein
the server device is further configured to:
send a notification indicating the registered item price and an item identification to the mobile terminal, and
the notification causes the mobile terminal to display a registration confirmation screen, via the shopping application, the registration confirmation screen including the registered item price and the item identification.

8. The transaction processing system according to claim 7, wherein the server device is further configured to:
receive a registration confirmation, via the registration confirmation screen, from the mobile terminal; and
register the item identification and the registered item price in a transaction list associated with the mobile terminal.

9. The transaction processing system according to claim 1, wherein
the weighing device further includes a display screen, and
the weighing device is further configured to:
when the weighing unit detects the reduction in the weight of items in the container, display an encoded image on the display screen, the encoded image including the weight change value corresponding to the reduction in weight and the weighing device code identifying the weighing unit.

10. The transaction processing system according to claim 9, further comprising:
a mobile terminal configured to execute a shopping application associated with a store in which the weighing device is located, the shopping application permitting a customer to register items for purchase in a sales transaction at the store, wherein
the mobile terminal is further configured to:
read the encoded image from the display screen; and
transmit a registration request to the server device, the registration request including the weight change value.

11. A transaction processing system for weighed commodities, the transaction processing system comprising:
a server device; and
a weighing device including:
a display screen
a weighing unit configured to detect a change in weight of items in a container on the weighing unit, wherein
when the weighing unit detects a reduction in the weight of items in the container, the weighing device generates an encoded image encoding a weight change value corresponding to the reduction in weight and a weighing device code identifying the weighing unit, and displays the encoded image on the display screen.

12. The transaction processing system according to claim 11, further comprising:
a mobile terminal configured to execute a shopping application associated with a store in which the weighing device is located, the shopping application permitting a customer to register items for purchase in a sales transaction at the store, wherein
the mobile terminal is further configured to:
read the encoded image from the display screen; and
transmit a registration request to the server device, the registration request including the weight change value.

13. The transaction processing system according to claim 11, further comprising:
a mobile terminal configured to execute a shopping application associated with a store in which the weighing device is located, the shopping application permitting a customer to register items for purchase in a sales transaction at the store.

14. The transaction processing system according to claim 13, wherein
the reading of the encoded image causes the mobile terminal to display a registration confirmation screen, via the shopping application, the registration confirmation screen including the weight change value, and an item identification corresponding to the items in the container on the weighing unit.

15. The transaction processing system according to claim 14, wherein the server device is further configured to:
receive a registration confirmation, via the registration confirmation screen, from the mobile terminal;
calculate a registered item price according to the weight change value and the item identification; and
register the registered item price and the item identification in a transaction list associated with the mobile terminal.

16. The transaction processing system according to claim 11, wherein
when the weighing unit detects the reduction in the weight of items in the container, the weighing device transmits a weight change notice to the server device via a communication unit, the weight change notice including the weight change value and a weighing device code identifying the weighing unit, and
upon receiving the weight change notice, the server device calculates a registered item price according to the weight change value and an item unit weight associated with the weighing device code in the server device.

17. The transaction processing system according to claim 16, further comprising:
a mobile terminal configured to execute a shopping application associated with a store in which the weighing device is located, the shopping application permitting a customer to register items for purchase in a sales transaction at the store, wherein
the server device is further configured to:
send a notification indicating the registered item price and an item identification to the mobile terminal, and
the notification causes the mobile terminal to display a registration confirmation screen, via the shopping application, the registration confirmation screen including the registered item price and the item identification.

18. A weighing device for transaction processing systems, the weighing device comprising:
a communication unit connectable to a server device; and
a weighing unit configured to detect a change in weight of items in a container on the weighing unit, wherein
when the weighing unit detects a reduction in the weight of items in the container, the weighing device transmits a weight change notice to the server device via the communication unit, the weight change notice including a weight change value corresponding to the reduction in weight and a weighing device code identifying the weighing unit.

19. The weighing device according to claim 18, wherein the weighing unit is a load cell.

20. The weighing device according to claim 18, further comprising:
a display screen, wherein
when the weighing unit detects the reduction in the weight of items in the container, the weighing device generates an encoded image encoding the weight change value corresponding to the reduction in weight and a weighing device code identifying the weighing unit, and displays the encoded image on the display screen.
